(19) United States
(12) Patent Application Publication
(10) Pub. No.: US 2006/0186156 A1
(43) Pub. Date: Aug. 24, 2006

(54) All terrain vehicle cargo rack

(75) Inventors: Ronald Mark Harycki, Matthews, NC (US); Jamie David Kovalaske, Pineville, NC (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/063,515

(22) Filed: Feb. 23, 2005

(51) Int. Cl. B60R 7/00; B60R 9/00; B60R 11/00

(52) U.S. Cl. 224/401; 224/42.33; 224/525

(57) ABSTRACT

A cargo rack for an all terrain vehicle has a tubular steel perimeter supported over the front and/or rear decks of the vehicle, and at least two cross members with opposing ends welded to the tubular steel perimeter. Each cross member has a platform area and width at least twice that of the tubular steel forming the perimeter.

### FIELD OF THE INVENTION

This invention relates to cargo racks for all terrain vehicles.

### BACKGROUND OF THE INVENTION

All terrain vehicles may be equipped with cargo racks over the front and/or rear decks of the vehicle. The rack provides a structure that may be intended to support a wide variety of different materials over the vehicle. Cargo or attachments may be strapped to the rack. The cargo rack on the front deck typically is intended to support a maximum of at least about 75 pounds, and the cargo rack on the rear deck typically is intended to support at least about 125 pounds.

In the past, most cargo racks on all terrain vehicles have been constructed of tubular steel. The diameter of each tubular steel member typically is between about ¾ inch and about 1 inch. The cargo rack may include a tubular steel perimeter with multiple tubular steel cross members spanning the perimeter to form a framework. The perimeter and cross members typically require a total length of between about 8 feet and about 15 feet of tubular steel. The gap between adjacent cross members of the cargo rack typically is preferred to be less than about 4 inches so that the cargo rack can provide adequate support for heavy or bulky cargo and/or attachments, or cargo having low rigidity such as sand or seed bags.

The ends of each tubular cross member are welded to the perimeter and/or to other cross members. Typically, at least about 8 to 12 ends of tubular cross members must be welded to the perimeter or to another cross member. This requires between about 24 inches and about 36 inches of welding to connect the ends of the tubular cross members to the circumference of other tubular steel members. Welding around the circumference of tubular steel members may involve turning over the cargo rack and/or repositioning the welding equipment, increasing the manufacturing cost.

As an alternative to tubular steel, some cargo racks may include stamped steel cross members. The width of the stamped steel cross members is the same or similar to that of the tubular steel members. Additionally, some cargo racks may include plastic panels that may bolt on to the rack. Although plastic panels may provide large surface area, they do not interface with attachments to the rack and do not provide structural support for the rack itself. Additionally, other cargo racks for all terrain vehicles have been injection molded or formed from a fiber-filled plastic resin with a steel substructure. This can be an expensive manufacturing process.

Existing cargo racks for all terrain vehicles have been satisfactory for carrying most cargo and/or attachments. However, other cargo and/or attachments cannot be fastened to a cargo rack easily using cords or straps that are tied, wound around or clamped to the perimeter or cross members. Additionally, some cargo and/or attachments may not be adequately supported by the tubular steel cross members of the cargo rack. Cargo and/or attachments with low rigidity, for example, may slip between the tubular cross members, or may not be held very securely in place.

Attachments such as baskets, sprayers or spreaders on existing cargo racks for all terrain vehicles may be positioned over vehicle features under the cargo rack such as storage compartments or fill lines. The attachment cannot be securely mounted or removed from the cargo rack without tools. As a result, the attachment to the cargo rack may block access to vehicle features on the front deck or rear deck such as storage compartments and fill lines.

There is a need for a lower cost cargo rack for the front and rear decks of an all terrain vehicle. There is a need for lower cost front and rear cargo racks that can support a maximum of at least about 75 pounds and 125 pounds respectively. There is a need for a cargo rack for an all terrain vehicle that requires less steel tubing. There is a need for a cargo rack for an all terrain vehicle that requires fewer welds and lower manufacturing cost. There is a need for attachments for a cargo rack for an all terrain vehicle that can be attached or removed without tools. There is a need for a cargo rack for an all terrain vehicle that provides better support for cargo and/or attachments. There is a need for a cargo rack for an all terrain vehicle that prevents cargo and/or attachments from slipping between the cross members. There is a need for a cargo rack attachment system for an all terrain vehicle that allows access to vehicle features under the cargo rack.

### SUMMARY OF THE INVENTION

A low cost cargo rack for an all terrain vehicle includes a perimeter of tubular steel having a front, left and right sides and a rear, a plurality of supporting legs between the tubular steel perimeter and vehicle frame, and a pair of generally parallel cross members spanning the perimeter. Each cross member has a width at least twice that of the tubular steel forming the perimeter and provides a supporting platform having a generally horizontal plane.

The cargo rack may be used on the front and/or rear decks of an all terrain vehicle, and can support a maximum of at least about 75 pounds on the front and about 125 pounds on the rear deck. The cargo rack requires less than 8 feet of steel tubing, and fewer welds than convention cargo racks for all terrain vehicles.

The cargo rack has mounting features in the cross members that allow cargo and/or attachments to be easily fastened with cords or straps. The horizontal support platforms of each cross member provide better support for cargo and/or attachments, and help prevent cargo and/or attachments from slipping between the cross members.

### BRIEF DESCRIPTION OF THE DRAWINGS

FIG. 1 is a top perspective view of a cargo rack for the front deck of an all terrain vehicle rack according to a first embodiment of the invention.

FIG. 2 is a top perspective view of a cargo rack for the rear deck an all terrain vehicle rack according to a second embodiment of the invention.

FIG. 3 is a bottom perspective view of a cargo rack with a basket attachment according to an embodiment of the invention.

FIG. 4 is a front perspective view of the front deck of an all terrain vehicle with a cargo rack according to the first embodiment.

### DESCRIPTION OF THE PREFERRED EMBODIMENT

In one embodiment of the invention shown in FIG. 1, cargo rack 10 may be mounted on the front of an all terrain vehicle. Cargo rack 10 may welded or bolted to the frame of the vehicle. The cargo rack may include tubular steel member 11 forming a perimeter with a front 12, left and right sides 13, 14, and rear 15. The tubular steel forming the cargo rack's perimeter may have a diameter of about ⅞ inches. Supporting legs may support cargo rack 10 in a generally horizontal plane over the front deck of the all terrain vehicle. For example, supporting legs may hold the front, left and right sides of the cargo rack's perimeter at a height between about one inch and about three inches over the front deck surface.

In one embodiment, to support the cargo rack over the front deck, supporting legs 26, 27 may connect the front of the perimeter to the vehicle frame, and supporting legs 28, 29 may connect the left and right sides of the perimeter to the vehicle front fenders. Additionally, supporting legs 30, 31 may connect the rear of the perimeter to the vehicle frame. One end of each supporting leg may be welded or bolted to the frame or body of the all terrain vehicle, and the other end may be welded or bolted to the perimeter of the cargo rack.

Optionally, as shown in FIG. 1, supporting legs 30, 31 may be connected to or integral with cargo stop 32. The cargo stop may extend to a height above that of the cargo rack's perimeter to help block cargo from shifting rearwardly off the cargo rack. For example, cargo stop 32 may be a one piece tubular steel member having an inverted U-shape. Ends 17, 18 of perimeter 11 may be welded to supporting legs 30, 31 of cargo stop 32.

In one embodiment, a pair of generally parallel cross members 21, 22 may span the perimeter of the cargo rack between front 12 and rear 15. Alternatively, the cross members may span the cargo rack between the left and right sides of the perimeter. There may be a gap of at least about 12 inches between the pair of cross members. Each cross member may have a width at least twice the diameter of the tubular steel forming the cargo rack's perimeter. For example, each cross member may have a width of about 4 inches, which is more than twice the ⅞ inch diameter of the tubular steel members forming the perimeter. Additionally, each cross member may have a surface or platform area that is at least twice the surface area of a tubular steel member with the same length. For example, each cross member may have a surface or platform area in a generally horizontal plane of at least about 30 square inches.

In one embodiment, each cross member may be stamped from sheet steel having a thickness between about ⅛ inch and about ⅜ inch. Alternatively, each cross member may be molded from plastic. Optionally, each cross member may be a channel with an M-shaped cross section. Alternatively, each cross member may be a channel with a C-shaped cross section. The M-shaped cross section may include a pair of platforms 23, 24 separated by trough 25. Each platform may have a width between about one inch and about two inches, and the trough may have a width between about one inch and two inches. The trough may be a maximum of about one inch below the platform surfaces.

In one embodiment, one end of each cross member may be welded to the front of the cargo rack's perimeter, and the other end welded to the rear of the cargo rack's perimeter. The cross members may provide sufficient load bearing support for cargo and attachments having a maximum weight of at least about 75 pounds over the front deck.

In one embodiment, cargo rack 10 has only two cross members. As a result, cargo rack 10 may be built at a lower cost than other racks. Fewer welds are needed to attach the ends of the two cross members to the cargo rack's perimeter, and the weld length for the two cross members totals a maximum of about 16 inches. Welding the ends of the two cross members is more efficient than welding the ends of multiple tubular steel members to the circumferences of other tubular steel members. The ends of the two cross members may be welded to the perimeter of the cargo rack without turning over the cargo rack and/or repositioning the welding equipment.

In one embodiment, as shown in FIG. 4, cargo rack 10 may be positioned on the front deck of an all terrain vehicle so that a feature on the front deck of the vehicle may be accessible in the gap between the two cross members. For example, the vehicle may have a cargo storage compartment 60 with a lid that may be above the surface of the front deck. Cargo rack 10 may be positioned on the deck surface so that the cargo enclosure or lid may be accessible in the gap of at least about 12 inches between the cross members. Additionally, cargo rack 10 may be positioned so that horizontal support platforms on the cross members may be at the same or similar plane as ribs or other surface feature on a cargo storage compartment on the front deck of the vehicle.

In one embodiment, each cross member may be provided with a plurality of mounting features 38. For example, several holes, keyholes, slots or other shapes may be stamped into the platforms and/or trough of each cross member 21, 22. The openings in the cross members may be used to attach cords or straps that secure cargo and/or attachments to the cargo rack.

In one embodiment, cargo rack 10 may be constructed from less than about 8 feet in length of ⅞ inch diameter steel tubing and less than about 3 square feet of sheet steel. For example, the combined length of perimeter 11 and cargo stop 20 may be less than 8 feet of tubular steel, and the cross members may require a total of less than 3 square feet of sheet steel. Alternatively, the cross members may be molded from plastic.

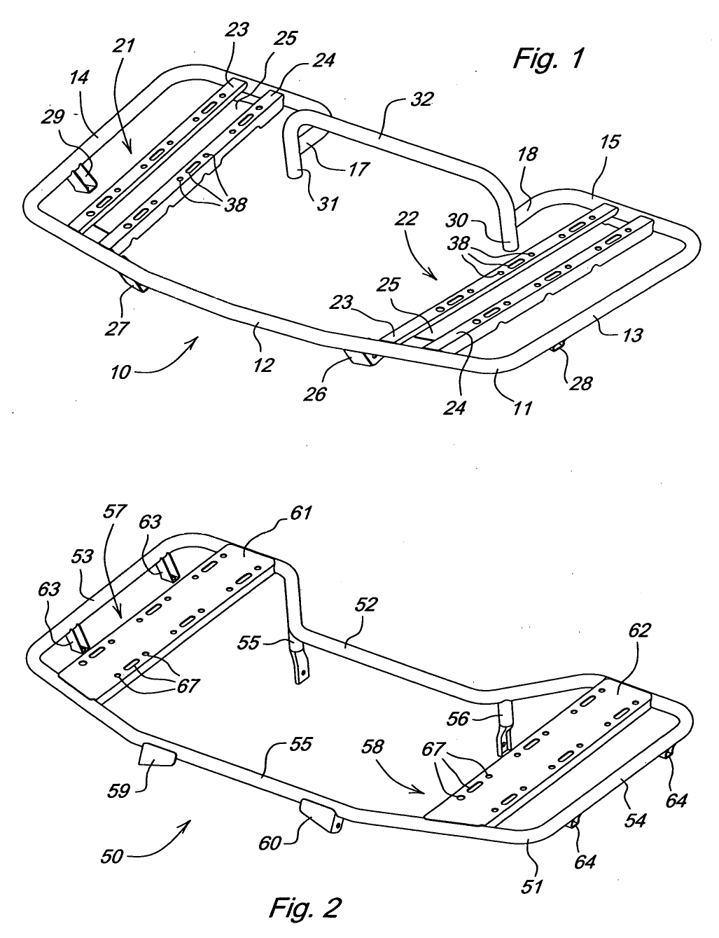

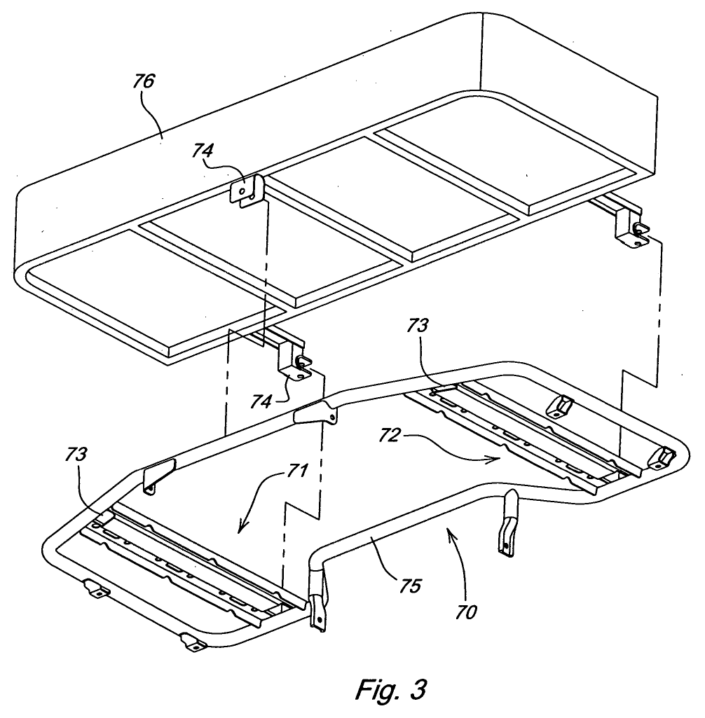

A second embodiment of the invention is shown in FIG. 2. In the second embodiment, cargo rack 50 may be mounted over the rear deck of an all terrain vehicle. Cargo rack 50 may be welded or bolted to the frame of the vehicle. Cargo rack 50 may include a tubular steel member 51 forming a perimeter with a front 52, left and right sides 53, 54, and rear 55. The tubular steel forming the cargo rack's perimeter may have a diameter of about ⅞ inches. The perimeter of cargo rack 50 may be constructed from less than about 8 feet in length of ⅞ inch diameter steel tubing, and the cross members may be constructed from less than about 3 square feet of sheet metal. Supporting legs may support cargo rack 50 in a generally horizontal plane over the rear deck of an all terrain vehicle. For example, supporting legs may hold the front, left and right sides of the cargo rack's perimeter at a height between about one inch and about three inches over the rear deck surface.

In a second embodiment, to support the cargo rack over the rear deck, supporting legs 55, 56 may connect the front of the perimeter to the vehicle frame, supporting legs 63, 64 may connect the left and right sides of the perimeter to the vehicle rear fenders or rear deck, and supporting legs 59, 60 may connect the rear of the perimeter to the vehicle frame. One end of each supporting leg may be welded or bolted to the frame or body of the all terrain vehicle, and the opposing end may be welded or bolted to the perimeter of the cargo rack.

In a second embodiment, a pair of cross members 57, 58 may span the perimeter of the cargo rack between front 52 and rear 55. Alternatively, the cross members may span between the left and right sides of the perimeter. Each cross member may have a width at least twice the diameter of the tubular steel forming the cargo rack's perimeter. For example, each cross member may have a width of about 4 inches, which is more than twice the ⅞ inch diameter of the tubular steel members forming the perimeter. Additionally, each cross member may have a horizontal surface area 61, 62 that is at least twice the surface area of the same length of ⅞ inch diameter tubular steel. For example, each cross member may have a surface area in a generally horizontal plane of at least about 30 square inches.

In a second embodiment, each cross member may be stamped from sheet steel having a thickness between about ⅛ inch and about ⅜ inch. Optionally, each cross member may be a channel with a C-shaped cross section, so that each cross member has a generally horizontal platform or support surface. Alternatively, each cross member may be a channel with an M-shaped cross section. The ends of each cross member may be welded to the front and rear of the cargo rack's perimeter.

In a second embodiment, cross members 57, 58 may provide sufficient load bearing support for cargo and attachments having a maximum weight of at least about 125 pounds over the rear deck. Only two cross members may be required. As a result, cargo rack 50 may be built at a lower cost than other racks. Fewer welds are needed to attach the pair of cross members to the cargo rack's perimeter, and the weld length for the pair of cross members totals not more than about 16 inches. Welding the ends of cross members 57, 58 also is more efficient than welding around the circumference of a tubular steel member, because the ends of cross members 57, 58 can be welded to the perimeter without turning over the cargo rack and/or repositioning the welding equipment.

In a second embodiment, each cross member may have mounting features 67. Several holes, keyholes, slots or other shapes may be stamped into the horizontal surface of each cross member 57, 58. The openings in the cross members may facilitate installation of a variety of different attachments, and/or may be used to attach cords or straps that secure cargo and/or attachments to the cargo rack.

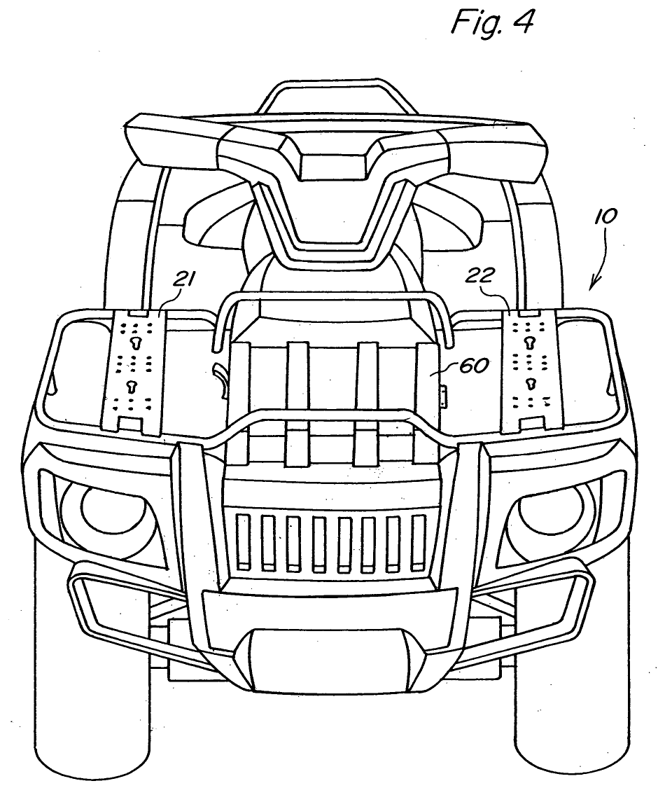

In a third embodiment shown in FIG. 3, the front and rear ends of one or both cross members 71, 72 may include cut-out portions 73. Each cut-out portion in the end of a cross member may have an area of between about one square inch and about six square inches. The cut-out portion may reduce the length of welds required to join the cross members to the perimeter. The cut-out portion also may allow attachment of clevis 74 to the perimeter 75 of the cargo rack where the cross member joins the perimeter.

In the embodiment of FIG. 3, attachment 76 may be quickly secured to or removed from cargo rack 70 manually and without tools. The attachment may have one or more, and preferably three, devises 74 that secure it to the cargo rack. Each clevis may be hand fastened or released manually with a clip or similar device, or tightened or loosened with a wing nut or the like. A variety of attachments may be secured to the cargo rack other than the basket shown in FIG. 3, such as a sprayer or spreader. The attachment may be securely attached to the cargo rack by positioning a clevis within the cut-out portion at the end of a cross member, and then securing the clevis to the perimeter. The cut-out portion not only helps position the clevis, but also prevents the clevis from dislodging or sliding from the desired position on the cargo rack's perimeter.

Having described the preferred embodiment, it will become apparent that various modifications can be made without departing from the scope of the invention as defined in the accompanying claims.

1. An apparatus comprising:
a perimeter of tubular steel having a front, left and right sides and a rear;
a plurality of supporting legs between the tubular steel perimeter and a frame of an all terrain vehicle; and
a pair of generally parallel cross members spanning the perimeter, each cross member having a width at least twice that of the tubular steel forming the perimeter and providing a supporting platform having a generally horizontal plane.

2. The apparatus of claim 1 wherein the pair of cross members are the only structure spanning the perimeter.

3. The apparatus of claim 1 wherein each cross member includes a plurality of mounting features.

4. The apparatus of claim 1 wherein each cross member has an M-channel cross section.

5. The apparatus of claim 1 wherein each cross member has a C-channel cross section.

6. The apparatus of claim 1 wherein there is a gap of at least 12 inches between the pair of cross members.

7. The apparatus of claim 1 further comprising an attachment mounted to the perimeter.

8. A cargo rack on a deck of an all terrain vehicle comprising:
a tubular steel perimeter supported over the deck of the all terrain vehicle;
at least two sheet steel cross members with opposing ends welded to the tubular steel perimeter, each cross member having a platform area and width at least twice that of the tubular steel forming the perimeter.

9. The cargo rack of claim 8 wherein each cross member includes a pair of platforms separated by a trough.

10. The cargo rack of claim 8 wherein each cross member has a plurality of mounting holes.

11. The cargo rack of claim 8 wherein each cross member has an end with a cut-out.

12. The cargo rack of claim 11 further comprising an attachment mounted on the cargo rack with a plurality of devises positioned in the cut-outs and secured to the perimeter of the cargo rack.

13. The cargo rack of claim 8 further comprising a cargo stop extending upwardly from the perimeter.

14. An apparatus comprising:
a cargo rack mounted to a deck of an all terrain vehicle including a perimeter and a pair of generally parallel cross members with a gap of at least 12 inches between the cross members, each cross member having a pair of platforms separated by a trough, each platform having a plurality of mounting features therein.

15. The apparatus of claim 14 wherein each cross member has opposing ends and further comprising a cut-out in the opposing ends of the trough separating the platforms.

16. The apparatus of claim 14 further comprising a plurality of supporting legs connecting the cargo rack to the all terrain vehicle.

17. The apparatus of claim 14 further comprising an attachment having a plurality of manually engageable and manually releasable devises securable to the perimeter of the cargo rack.

18. The apparatus of claim 14 wherein each cross member has an area of at least about 30 inches.

19. The apparatus of claim 14 wherein the perimeter is tubular steel.

20. The apparatus of claim 14 wherein the platforms are plastic.
